(19) United States
(12) Patent Application Publication
(10) Pub. No.: US 2014/0117627 A1
(43) Pub. Date: May 1, 2014

(54) Sealing Assembly

(71) Applicant: Rudiger Franke, Loerrach (DE)

(72) Inventor: Rudiger Franke, Loerrach (DE)

(73) Assignee: RHEINFELDEN ALLOYS GMBH & CO. KG, Rheinfelden (DE)

(21) Appl. No.: 14/111,853

(22) PCT Filed: May 9, 2012
(86) PCT No.: PCT/EP2012/058581

§ 371 Date: Nov. 20, 2013

(30) Foreign Application Priority Data
May 11, 2011 (EP) 11165711.0

(51) Int. Cl. F16J 15/16

(52) U.S. Cl. CPC F16J 15/16
USPC 277/500

(57) ABSTRACT

An assembly for sealing a shaft, which shaft is arranged in a container filled with a liquid melt consisting of aluminum or an aluminum alloy, passes through an opening in a wall of the container, and rotates about a shaft axis and/or moves back and forth in the direction of the shaft axis, including at least one annular sealing element that encompasses the shaft. The at least one annular sealing element is made of carbon, a ceramic material, or a metal material and is arranged outside of the container, and the shaft is provided with a coating made of carbon, a ceramic material, or a metal material in the encompassing area of the at least one annular sealing element, wherein the wear resistance of the coating on the shaft is the same as or higher than the wear resistance of the at least one annular sealing element.

The invention relates to an assembly for sealing a shaft, which is arranged in a container filled with a liquid melt made of aluminum or an aluminum alloy and which passes through an opening in a wall of the container and rotates about a shaft axis and/or moves back and forth in the direction of the shaft axis, comprising at least one annular sealing element that encloses the shaft.

It is known to prevent liquid metal from leaking when shafts pass through a container wall by arranging packing cords made of fireproof material so as to seal containers holding liquid metal melt. This type of seal is not suited for highly loaded movable parts in continuous operation.

It is the object of the invention to seal a shaft which is in contact with a liquid melt made of aluminum alloy and rotates about a shaft axis and/or moves back and forth in the direction of the shaft axis.

The object is achieved according to the invention for an assembly of the type mentioned above in that the at least one sealing element is made of carbon, a ceramic or a metallic material and is arranged outside the container, and that the shaft is provided with a covering made of carbon, a ceramic or a metallic material in the enclosing region of the at least one sealing element, wherein the wear resistance of the covering on the shaft is equal to or greater than the wear resistance of the at least one sealing element.

The covering may be a coating that is applied to the shaft. However, a preferred covering is formed by a hollow-cylindrical part that is fixed on the shaft.

The sealing elements are advantageously arranged in a sealing housing that is fixed with respect to the shaft.

At an operating temperature of approximately 550° C. to 650° C., the sealing elements in the housing preferably have a transition fit or a slight interference fit with the coating that is applied to the shaft, or with the hollow-cylindrical part that is fixed on the shaft.

The sealing elements are preferably made of graphite, diamond-like carbon (DLC), zirconium oxide, aluminum titanate, boron nitride, tungsten, or a mixture of at least two of these materials.

The coating that is applied to the shaft, or the hollow-cylindrical part that is fixed on the shaft, is preferably made of diamond-like carbon (DLC), zirconium oxide, aluminum titanate, silicon nitride, boron nitride, tungsten, or a mixture of at least two of these materials.

The sealing elements can be designed as closed rings or sleeves, as split rings or as segmented rings, in particular as rings composed of two half shells.

The shaft is preferably made of a steel material, and the coating that is applied to the shaft, or the hollow-cylindrical part that is fixed on the shaft, preferably has a lower thermal coefficient of expansion than the steel material of the shaft.

In a preferred assembly, at least one gas supply line is arranged in the sealing housing for supplying inert gas into a sealing gap formed between the sealing elements and the coating that is applied to the shaft, or the hollow-cylindrical part that is fixed on the shaft.

In a particularly preferred embodiment, an annular sealing element has an outer circumferential groove and an inner circumferential groove, and the grooves are connected to each other by radial channels.

Further advantages, characteristics and details of the invention will be apparent from the following description of preferred exemplary embodiments and based on the drawings, which are only provided for explanation and shall not be interpreted to be limiting. In the schematic drawings:

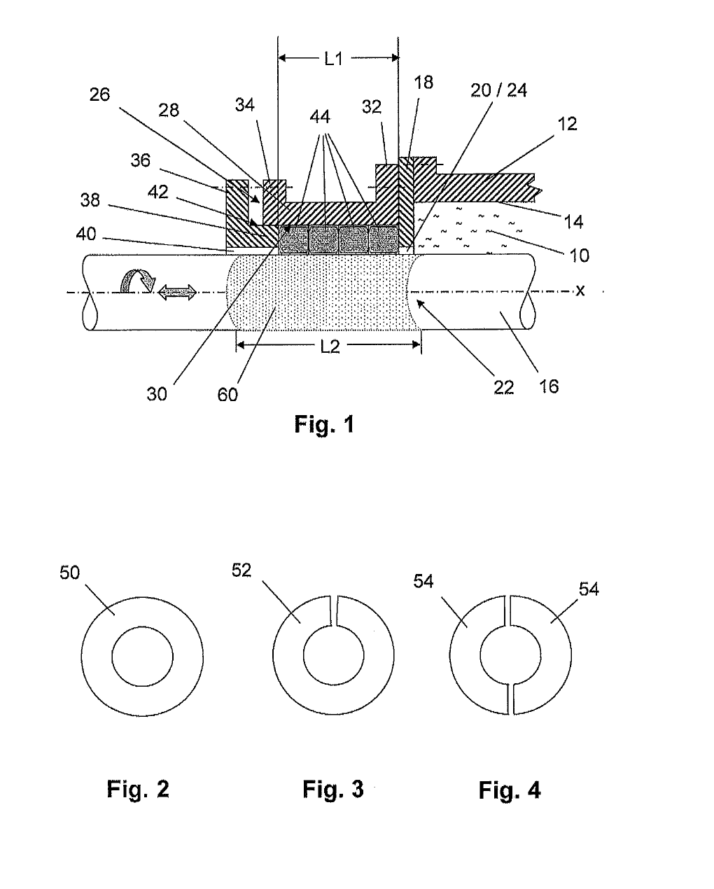

FIG. 1 shows a longitudinal sectional view through a first embodiment of an assembly, comprising sealing elements for sealing a shaft penetrating a wall of a container;

FIG. 2 shows a top view in the axial direction onto a first embodiment of a sealing element;

FIG. 3 shows a top view in the axial direction onto a second embodiment of a sealing element;

FIG. 4 shows a top view in the axial direction onto a third embodiment of a sealing element;

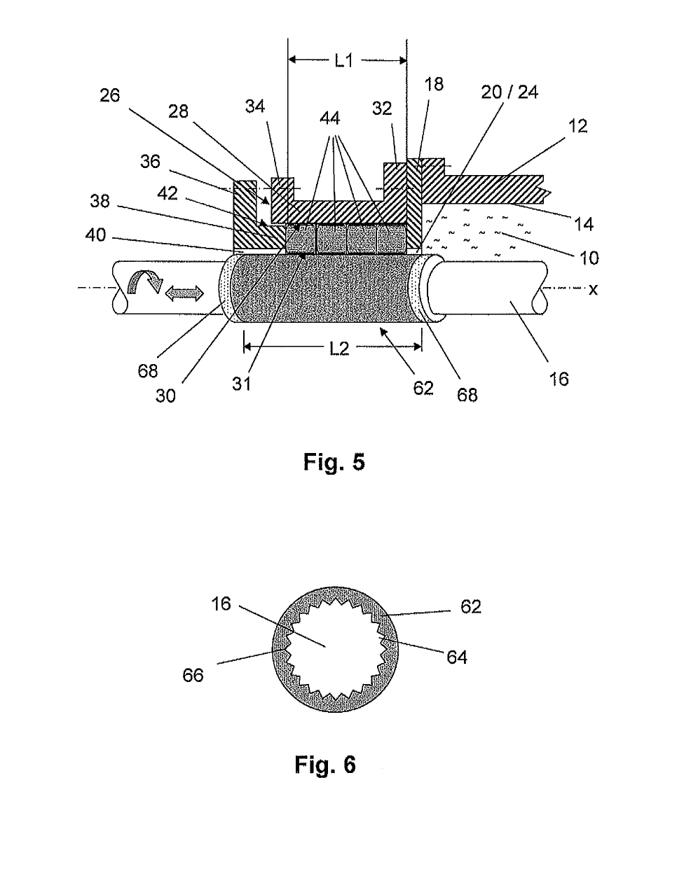

FIG. 5 shows a longitudinal sectional view through a second embodiment of an assembly, comprising sealing elements for sealing a shaft penetrating a wall of a container;

FIG. 6 shows a cross-section through the shaft of FIG. 5 in the region of the sealing elements;

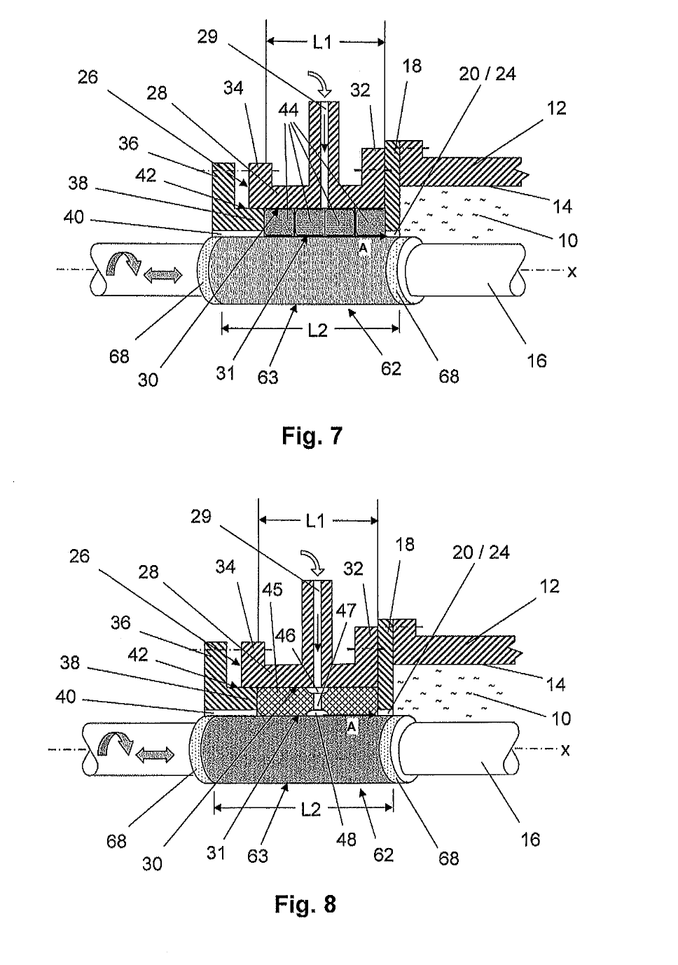

FIG. 7 shows a longitudinal sectional view through a third embodiment of an assembly, comprising sealing elements for sealing a shaft penetrating a wall of a container; and

FIG. 8 shows a longitudinal sectional view through a fourth embodiment of an assembly, comprising a sealing element for sealing a shaft penetrating a wall of a container.

A first embodiment of a sealing assembly shown in FIG. 1 shows a sub-region of a container 12 which is filled with a liquid melt 10 made of aluminum or an aluminum alloy and comprises a cylindrical inner wall 14 and a shaft 16 having a shaft axis x which is arranged in the container 12 concentrically to the inner wall 14. The shaft 16 passes to the outside through an opening 20 of an end wall 18 of the container 12 arranged at a right angle with respect to the shaft axis x, wherein an annular gap 24 remains as radial play for the shaft 16 in the end wall 18 between the edge of the opening 20 and the lateral face 22 of the shaft 16 for unimpaired rotatability and axial displaceability of the shaft 16.

On the outside of the container 12, a housing part 28 of the sealing housing 26 which encloses the shaft 16 and has a cylindrical inner lateral face 30 concentric to the shaft axis x, is flanged onto the end wall 18 of the container 12 by way of a first attachment flange 32.

At the end remote from the end wall 18, the sealing housing 26 is connected by way of a second attachment flange 34 to a connecting flange 36 for attaching a drive device, which is not shown in the drawing, for rotating the shaft 16 and moving it axially back and forth. A cylindrical pipe shoulder 38 of the connecting flange 36 encloses the shaft 16, leaving an annular gap 40 for maintaining a radial play for the shaft 16. The cylindrical outer lateral face 42 of the pipe shoulder 38 extends into the housing part 28 and is slideably seated against the cylindrical inner lateral face 30 of the housing part 28.

The housing part 28 of the sealing housing 26 encloses annular sealing elements 44, which in turn enclose the shaft 16. In the example shown, four sealing elements 44 are arranged next to each other seated against the shaft 16. A first of the four sealing elements 44 is seated against the end face 18. On the other side, the pipe shoulder 38 is non-positively seated against the last of the four sealing elements 44 at the end face by way of an adjustable spring force.

The sealing elements can be designed as closed rings 50 or sleeves (FIG. 2), as split rings 52 (FIG. 3) or as segmented rings (FIG. 4), for example composed of two half shells (54). The number of sealing elements 44 can be arbitrarily selected and generally ranges between approximately 3 and 10.

The sealing elements 44 extend over an axial length L1 within the housing part 28. The region of the lateral face 22 of the shaft 16 which is seated against the sealing elements 44 is provided with a coating 60 over an axial length L2, which essentially corresponds to the length L1, plus the axial displacement component of the shaft 16 moving back and forth during operation.

The material for the coating 60 of the shaft 12 in the region of the seal is selected so that the wear resistance of the coating 60 is equal to or greater than the wear resistance of the sealing elements 44. Suitable coatings for the shaft 16 in the sealing region are carbon, ceramic or metallic coatings. Examples of coating materials include, for example, diamond-like carbon (DLC), zirconium oxide, aluminum titanate, boron nitride, silicon nitride and tungsten.

Suitable materials for the sealing elements 44 are carbon in the form of graphite, ceramic materials or metals, wherein care must be taken that the wear resistance of the sealing elements 44 is equal to or lower than the wear resistance of the coating 60 of the shaft 16 in the sealing region.

In addition, care must be taken that the thermal coefficient of expansion of the coating is similar to that of the steel material of the shaft 16. In this way, the coating can be prevented from spalling during heating to the operating temperature.

A smooth design of the coating 60 on the shaft 16 is particularly preferred. In addition, no or only low wetting of the coating 60 and of the sealing elements 44 by liquid melt made of aluminum or an aluminum alloy is aspired, as is a chemical resistance of the material for the coating 60 of the shaft 16 and of the material for the sealing elements 44 up to a temperature of approximately 800° C.

Compared to the steel material of the shaft 16 and further components, the sealing elements 44 have similar but lower thermal expansion.

The dimensions of the sealing elements 44 are selected so that a transition fit or a slight interference fit with the shaft develops at the operating temperature.

Deviating from the sealing assembly shown in FIG. 1, a hollow-cylindrical part 62 is arranged on the shaft 16 instead of the coating 60 of the shaft 16 in the assembly according to FIG. 5. A plurality of parallel longitudinal grooves 64 extend in the direction of the shaft axis x on the inner lateral face of the hollow-cylindrical part 62, and a plurality of parallel longitudinal teeth 66 are arranged in the direction of the shaft axis x on the shaft 16 (FIG. 5). The multiple toothing configurations thus formed between the hollow-cylindrical parts 62 and the shaft 16 creates a positive fit in the circumferential direction, so that the hollow-cylindrical part 62 is seated on the shaft 16 in a torsion-proof manner. In the example shown, groove nuts 68 screwed onto the shaft 16 on both sides of the hollow-cylindrical parts 62 are used to axially secure and fix the hollow-cylindrical part 62 on the shaft 16. The positive fit in the circumferential direction can also be achieved by way of other known elements, for example by way of a feather key.

Suitable materials for the hollow-cylindrical parts 62 of the shaft 16 in the region of the seal are diamond-like carbon (DLC) and ceramic materials, in particular boron nitride (BN) and silicon nitride (Si₃N₄). As with the coating 60, care is again taken that the wear resistance of the hollow-cylindrical part 62 is equal to or greater than the wear resistance of the sealing elements 44. A particularly suited sealing assembly is composed of a hollow-cylindrical parts 62 made of silicon nitride (Si₃N₄) having wear resistance that is higher than boron nitride (BN), and four sealing elements 44 in the form of rings 50 made of boron nitride (BN) or graphite (C) in the arrangement BN-C-C-BN, BN-C-BN-C or BN-BN-C-C, wherein the first ring in direct contact with the metal melt is made of BN in each case

The sealing assembly shown in FIG. 7 differs from the sealing assembly according to FIG. 5 by one or more gas supply lines 29 arranged in the housing part 26 for supplying inert gas into the sealing gap formed between the lateral face 63 of the hollow-cylindrical part 62 and the inner lateral face 31 of the sealing element 44.

The sealing assembly shown in FIG. 8 corresponds to the sealing assembly according to FIG. 7, wherein here a single sealing element 45 is present instead of four sealing elements 44. The sealing element 45 has an outer circumferential groove 46 and an inner circumferential groove 48. The two grooves 46, 48 are connected by radial channels 47 so that inert gas supplied via the gas supply lines 29 flows through the sealing element 45 in the radial direction and can reach the sealing gap formed between the lateral face 63 of the hollow-cylindrical part 62 and the inner lateral face 31 of the sealing element 45.

In both sealing assemblies, the gas flow through the gas supply lines 29 is set in such a way that a gas pressure, which is shown by an arrow A in the drawing, is built by the inert gas in the sealing gap formed between the lateral face 63 of the hollow-cylindrical part 62 and the inner lateral face 31 of the sealing element 44 or the sealing element 45, this pressure counteracting the penetration of liquid metal metal 10 into the sealing gap. Suitable inert gas is nitrogen (N₂) or argon (Ar), for example.

A sealing assembly described above is suited, for example, for operating a mixing and kneading machine for producing partially solid aluminum alloys, as they are used, for example, in the method known from WO 2011/116838 A1 for producing diecast parts. Such a mixing and kneading machine comprises a container in the form of a housing, in which a worm shaft rotating about a longitudinal axis and moving back and forth in the longitudinal axis in a translatory manner is arranged. A drive shaft arranged concentrically to the worm shaft is guided out of the container at the end face and is operatively connected to a drive unit for carrying out a rotational movement of the worm shaft and to a device cooperating with the worm shaft for simultaneously carrying out the translatory movement of the worm shaft in the shaft axis.

1. An assembly for sealing a shaft, which is arranged in a container filled with a liquid melt made of aluminum or an aluminum alloy and which passes through an opening in a wall of the container, and rotates about a shaft axis and/or moves back and forth in the direction of the shaft axis, comprising at least one annular sealing element that encloses the shaft,
wherein the at least one annular sealing element is made of carbon, a ceramic or a metallic material and is arranged outside the container, and that the shaft is provided with a covering made of carbon, a ceramic or a metallic material in the enclosing region of the at least one annular sealing element, and the wear resistance of the covering on the shaft being equal to or greater than the wear resistance of the at least one annular sealing element.

2. The assembly according to claim 1, wherein the covering is a coating that is applied to the shaft.

3. The assembly according to claim 1, wherein the covering is a hollow-cylindrical part that is fixed on the shaft.

4. The assembly according to claim 1, wherein the at least one annular sealing element is arranged in a sealing housing that is fixed with respect to the shaft.

5. The assembly according to claim 1, wherein the at least one annular sealing element has a transition fit or a slight interference fit with the covering on the shaft at an operating temperature of approximately 550° C. to 650° C.

6. The assembly according to claim 1, wherein the at least one annular sealing element is made of graphite, diamond-like carbon (DLC), zirconium oxide, aluminum titanate, boron nitride, tungsten, or a mixture of at least two of these materials.

7. The assembly according to claim 1, wherein the covering on the shaft is made of diamond-like carbon (DLC), zirconium oxide, aluminum titanate, silicon nitride, boron nitride, tungsten, or a mixture of at least two of these materials.

8. The assembly according to claim 1, wherein the at least one annular sealing element is designed as a closed ring or sleeve, as a split ring, or as a segmented ring.

9. The assembly according to claim 1, wherein the shaft is made of a steel material, and the thermal coefficient of expansion of the covering on the shaft is lower than that of the thermal coefficient of expansion of the steel material of the shaft.

10. The assembly according to claim 4, wherein at least one gas supply line is arranged in the sealing housing for supplying inert gas into a sealing gap formed between the at least one annular sealing element and the covering on the shaft.

11. The assembly according to claim 10, wherein the at least one annular sealing element comprises an outer peripheral groove and an inner peripheral groove, and the grooves are connected to each other by radial channels.

12. The assembly according to claim 8, wherein the segmented ring is composed of two half shells.
